(19) United States
(12) Patent Application Publication
(10) Pub. No.: US 2021/0167416 A1
(43) Pub. Date: Jun. 3, 2021

(54) LITHIUM ION SECONDARY BATTERY, AND SYSTEM FOR AND METHOD OF MANUFACTURING SAME

(71) Applicants: HYUNDAI MOTOR COMPANY, Seoul (KR); KIA MOTORS CORPORATION, Seoul (KR)

(72) Inventors: Sang Jin Park, Bucheon-si (KR); Young Woo Lee, Suwon-si (KR); Sang Mok Park, Gwangju-si (KR)

(21) Appl. No.: 16/872,911

(22) Filed: May 12, 2020

(30) Foreign Application Priority Data
Nov. 29, 2019 (KR) 10-2019-0156296

(51) Int. Cl. H01M 10/0525; H01M 4/36; H01M 4/62; H01M 10/04; H01M 4/04

(52) U.S. Cl. CPC H01M 10/0525; H01M 4/366; H01M 4/0404; H01M 10/0404; H01M 4/623

(57) ABSTRACT

Disclosed is a lithium ion secondary battery. The lithium ion secondary battery includes a cathode electrode including a cathode current collector and a cathode coating layer surrounding the cathode current collector, resistive layers formed on respective side surfaces at respective ends of the cathode electrode, an anode including an anode current collector and an anode coating layer surrounding the anode current collector, and a separator disposed between the cathode electrode and the anode electrode.

### CROSS REFERENCE TO RELATED APPLICATION

The present application claims priority to Korean Patent Application No. 10-2019-0156296, filed Nov. 29, 2019, the entire contents of which is incorporated herein for all purposes by this reference.

### BACKGROUND

### Field of the Disclosure

The present disclosure relates to a lithium ion secondary battery and a system for and method of manufacturing same. More particularly, the present disclosure relates to a lithium ion secondary battery with improved quick charging characteristics and a system for and method of manufacturing same.

### Description of the Related Art

In electric vehicles, the mileage per charge is used as an indicator of the performance. The mileage per charge increases with energy density of each battery cell or with the number of battery cells mounted in an electric vehicle. When increasing the mileage per charge by increasing the energy density of each battery cell or the number of battery cells mounted in an electric vehicle, there are problems such as technical limitations and rising costs. For this reason, quick charging technology has been recently paid attention. When vehicle batteries can be charged fast, the charging time per charge decreases, resulting in convenient use of electric vehicles. That is, it is possible to improve customer satisfaction for electric vehicles without increasing the battery cost.

However, when a charge current is excessively higher than a predetermined level when a lithium ion secondary battery is quick-charged to reduce charging time, lithium precipitation and electrolyte reaction byproducts occur on an anode arranged to face trimmed surfaces of a cathode. The materials accumulate more and more with charge and discharge cycles of a lithium ion secondary battery, resulting in damage to a separator. This consequently results in short-circuiting and ignition.

The foregoing is intended merely to aid in understanding the background of the present disclosure and therefore should not be interpreted to admit that the present disclosure falls within the purview of the related art that is already known to those skilled in the art.

### SUMMARY

The present disclosure is provided to propose a solution to the above problems occurring in the related art. A first objective of the present disclosure is to provide a lithium ion secondary battery in which a resistive layer is formed on a trimmed surface of a cathode electrode, in which the resistive layer restricts movement of electrons or lithium ions moving through the trimmed surface of the cathode, thereby minimizing the amount of lithium precipitation and the amount of electrolyte reaction byproducts formed on the trimmed surface of the cathode electrode, resulting in improvement in quick charge characteristics. In addition, due to the presence of the resistive layer on the trimmed surface of the cathode electrode, material cost is reduced. A second objective of the present disclosure is to provide a system for manufacturing a lithium ion secondary battery. A third objective of the present disclosure is to provide a method of manufacturing a lithium ion secondary battery.

In order to accomplish the first objective, according to one aspect of the present disclosure, there is provided a lithium ion secondary battery including: a cathode including a cathode current collector and a cathode coating layer formed on a surface of the cathode current collector; resistive layers formed on respective side surfaces at respective ends of the cathode; an anode including an anode current collector and an anode coating layer formed on a surfaced of the anode current collector; and a separator disposed between the cathode and the anode.

The resistive layer may be made of a mixture of a conductive material and a binder.

The conductive material and the binder may be mixed at a ratio of 1:1.1 to 1:10.

The resistive layers formed on the respective side surfaces at the respective ends of the cathode may be coated with a mixture solution of a binder and a solvent.

The binder may include one or more materials selected from the group consisting of carboxymethyl cellulose (CMC), styrene butadiene rubber (SBR), polyacrylic acid (PAA), poly(vinylidene fluoride) (PVdF), poly(vinyl alcohol) (PVA), and polyimide (PI).

The solvent may include one or more materials selected from the group consisting of alcohol, pure water, methyl-2-pyrrolidone (NMP), dimethylformamide (DMF), dimethylacetamide (DMA), and tetrahydrofuran (THF).

The concentration of the mixture solution may be in a range of from 0.5% to 20%.

The mixture solution may include a solvent, one or more monomers, and an initiator.

The monomer may include a vinyl group, an alkyl group, or any combination of a vinyl group and an alkyl group.

The monomer may include: at least one material selected from the group consisting of alkyl methacrylate, alkyl acrylate, acrylonitrile, alkyl acetate, styrene, and butadiene; vinyl alcohol; or a combination of vinyl alcohol and at least one material selected from the group consisting of alkyl methacrylate, alkyl acrylate, acrylonitrile, alkyl acetate, styrene, and butadiene.

The concentration of the initiator may be 0.5% to 5% by weight with respect to the total weight of the monomer.

The mixture solution may include a metal oxide or a metal hydroxide in a concentration of 0.5% to 5% with respect to the total weight of the mixture solution.

In order to accomplish the second objective of the present disclosure, according to one aspect, there is provided a lithium ion secondary battery manufacturing system including: a cutter/coater configured to trim a cathode electrode to have a predetermined size and to coat trimmed surfaces at respective ends of the cathode electrode with a coating solution to form resistive layers on the respective trimmed surfaces; an electrode feeder configured to feed the cathode electrode to the cutter/coater; an electrode discharger configured to discharge the trimmed and coated cathode electrode from the cutter/coater; and a coating solution feeder configured to feed the coating solution to the cutter/coater.

The system may further include at least one device selected from among: a coating solution container for storing the coating solution; a vacuum device configured to create a negative pressure at around the trimmed surfaces of the cathode electrode before the coating solution is sprayed by the cutter/coater and configured to remove the residue of the coating solution after the coating solution is sprayed; a cleaning solution feeder configured to feed a cleaning solution to the trimmed surfaces of the cathode electrode; a particle remover configured to remove particles escaping from the trimmed surfaces of the cathode electrode; and a dryer configured to dry the coated surfaces of the cathode electrode.

The cutter/coater may include an upper mold and a lower mold.

The upper mold may include: a cutter being vertically movable and configured to trim the cathode electrode; a fixing part configured to fix the cathode electrode when trimming the cathode electrode; and a coater configured to spray the coating solution to the trimmed surfaces of the cathode electrode.

The lower mold may include: a mounting portion in which the cathode electrode is mounted; and a support portion that is vertically movable, that supports the cathode electrode mounted in the mounting portion from the sides of the cathode electrode, that moves downward when both sides of the cathode electrode is trimmed by the cutter, and that supports the cathode electrode from the trimmed side surfaces.

In order to accomplish the third objective of the present disclosure, according to one aspect, there is provided a method of manufacturing a lithium ion secondary battery, the method including: loading a cathode electrode into a cutter/coater; lowering an upper mold of the cutter/coater to move a cutter downward while fixing a cathode electrode with a fixing part in order to trim the cathode electrode to have a predetermined size; moving the cuter upward while fixing the trimmed cathode electrode with the fixing part; spraying a coating solution to form resistance layers on respective trimmed surfaces of the cathode electrode; and unloading the trimmed and coated cathode electrode.

The method may further include a step of removing particles escaping from the trimmed surfaces of the cathode electrode before the coating of the trimmed surfaces of the cathode electrode.

The method may further include a step of drying the trimmed and coated cathode electrode before the unloading of the trimmed and coated cathode electrode.

The method may further include a step of stacking multiple cathode electrodes trimmed to have a predetermined size and a step of forming restive layers on trimmed surfaces of the multiple cathode electrodes stacked on each other after the moving of the cutter while fixing the cathode electrodes.

According to the present disclosure, since the resistive layers are formed on the respective trimmed surfaces of the cathode electrode, it is possible to restrict the movement of electrons or lithium ions moving out through the trimmed surfaces the cathode electrode, thereby minimizing the amount of lithium precipitation and the amount of electrolyte reaction by-products accumulated on the trimmed surfaces of the cathode electrode, resulting in improvement in quick charge characteristics. In addition, since the thickness of the cathode electrode increases due to the presence of the resistive layers, it is possible to reduce the material cost.

### BRIEF DESCRIPTION OF THE DRAWINGS

FIG. 1 is a view illustrating a conventional lithium ion secondary battery in which lithium precipitates or electrolyte reaction byproducts occur on an anode arranged to face a section of a cathode during quick charging of the lithium ion secondary battery;

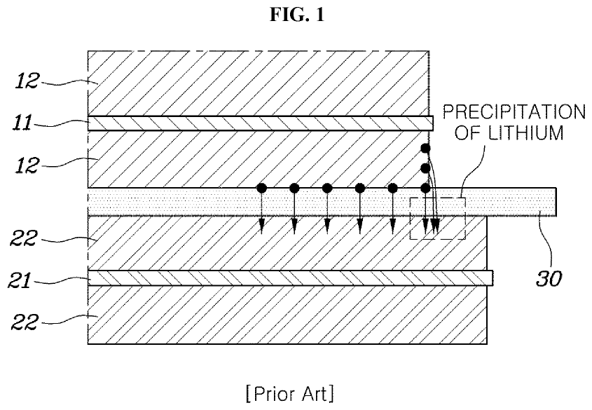

FIG. 2 is a schematic view illustrating the construction of a lithium ion secondary battery according to one exemplary embodiment of the present disclosure;

FIG. 3 is an enlarged view of a portion A of FIG. 2;

FIG. 4 is an enlarged view of a portion B of FIG. 3;

FIG. 5 is a view illustrating the overall construction of a lithium ion secondary battery manufacturing system according to one exemplary embodiment of the present disclosure;

FIG. 6 is a view illustrating the overall construction of a lithium ion secondary battery manufacturing system according to another exemplary embodiment of the present disclosure;

FIG. 7 is a view illustrating a method of manufacturing a lithium ion secondary battery, according to a first exemplary embodiment of the present disclosure;

FIG. 8 is a view illustrating a method of manufacturing a lithium ion secondary battery, according to a second exemplary embodiment of the present disclosure; and

FIG. 9 is a view illustrating a method of manufacturing a lithium ion secondary battery, according to a third exemplary embodiment of the present disclosure.

### DETAILED DESCRIPTION

Hereinafter, exemplary embodiments of the present disclosure will be described with reference to the accompanying drawings. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe its invention in the best way possible.

The exemplary embodiments described herein and the configurations illustrated in the drawings are presented for illustrative purposes and do not exhaustively represent the technical spirit of the present invention. Accordingly, it should be appreciated that there will be various equivalents and modifications that can replace the exemplary embodiments and the configurations at the time at which the present application is filed.

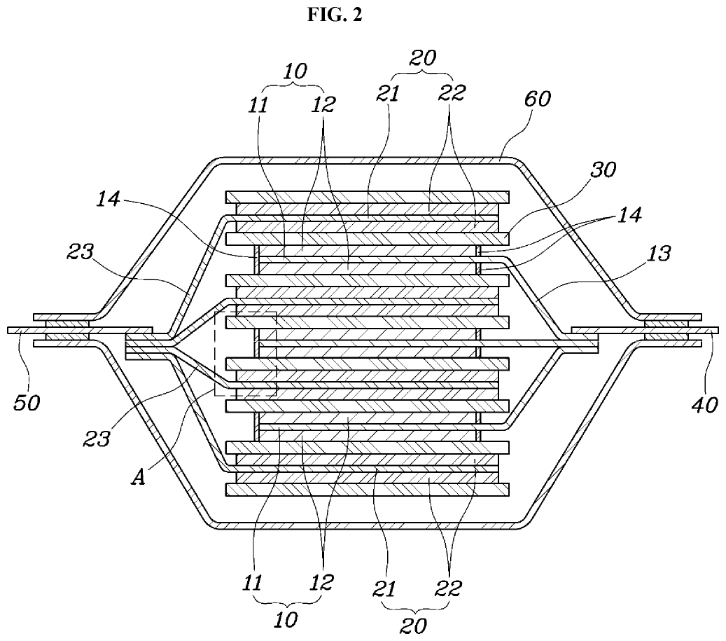

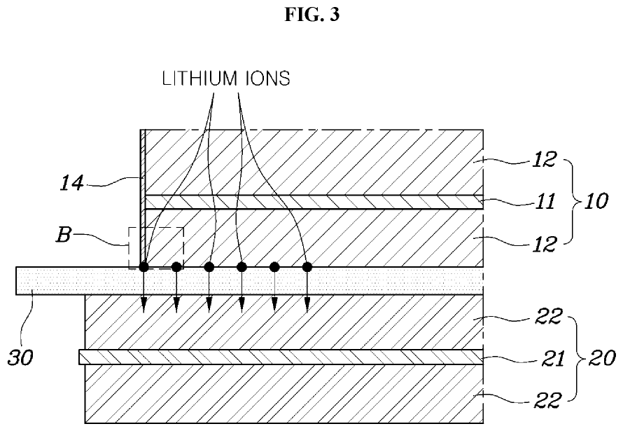

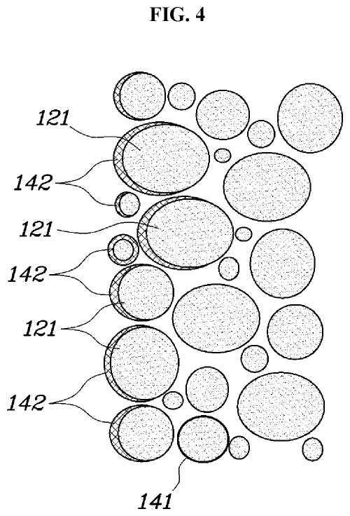

FIG. 2 is a schematic view illustrating the construction of a lithium ion secondary battery according to one exemplary embodiment of the present disclosure, FIG. 3 is an enlarged view of a portion A of FIG. 2, and FIG. 4 is an enlarged view of a portion B of FIG. 3.

Referring to FIG. 2, a lithium ion secondary battery according to one exemplary embodiment of the present disclosure includes a cathode electrode 10, a resistive layer 14, an anode electrode 20, and a separator 30. The lithium ion secondary battery may further include a cathode tab 40, an anode tab 50, and a casing 60.

The cathode electrode 10 includes a cathode current collector 11 and a cathode coating layer 12 coated on the surface of the cathode current collector 11. The cathode current collector 11 can be made of any conductive material. Depending on embodiment, the cathode current collector 11 may be made of aluminum, stainless steel, or nickel-plated steel.

The cathode coating layer 12 is formed on the surface of the cathode current collector 11. The cathode coating layer 12 includes a cathode active layer made of a cathode active material and a binder and a conductive material formed on the cathode active layer. For example, the cathode active material may be a solid solution oxide containing lithium. However, the cathode active material is not limited to a specific material if the material can electrochemically absorb and release lithium ions.

The anode electrode 20 includes an anode current collector 21 and an anode coating layer 22 coated on the surface of the anode current collector 21. The anode current collector 21 can be made of any conductive material. Depending on embodiment, the anode current collector 11 may be made of copper, aluminum, stainless steel, or nickel-plated steel. However, the material of the anode current collector 11 is not limited thereto.

The anode coating layer 22 is formed on the surface of the anode current collector 21. The anode coating layer 12 includes an anode active layer made of an anode active material and a binder and a conductive material formed on the anode active layer. Here, the anode active materials include metal-based active materials and carbon-based active materials. The metal-based active materials include silicon-based active materials, tin-based active materials, and any combination thereof. The carbon-based active material is a material that contains carbon (atoms) and which can electrochemically absorb and release lithium ions. Examples of the carbon-based active material include a graphite active material, artificial graphite, natural graphite, a mixture of artificial graphite and natural graphite, natural graphite coated with artificial graphite, but are not limited thereto.

The separator 30 is positioned between the cathode electrode 10 and the anode electrode 20 to electrically isolate the cathode electrode 10 and the anode electrode 20 from each other. The separator 30 is a porous membrane allowing ions to pass through so that the ions can move between the cathode electrode 10 and the anode electrode 20.

The cathode electrode tab 40 is welded to a portion of the cathode current collector 11 at a position where the coating layer is not formed, thereby allowing electric charges to flow to the outside.

The anode tab 50 is welded to a portion of the anode current collector 21 at a position where the coating layer is not formed, thereby allowing electric charges to flow to the outside.

The casing 60 serves to isolate the electrode assembly contained in the casing, thereby preventing the electrode assembly from being exposed to ambient air and moisture.

The resistive layers 14 are the key element of the present disclosure and they are layers respectively formed on both end faces of the cathode electrode 10. The end faces of the cathode electrode 10 mean cross-sections of the cathode electrode.

The resistive layers 14 are made of a mixture of a conductive material and a binder. Specifically, the mixing ratio of the conductive material and the binder that constitute the resistive layer 14 may be in a range of 1:1.1 to 1:10.

Referring to FIGS. 3 and 4, the resistive layer 14 is made of a mixture of the conductive material 141 and the binder 142, and the resistive layer 14 can be called a highly contained binder layer in which the content of the binder is relatively high in comparison with the other portions of the cathode coating layer so that the electric conductivity of the resistive layer 14 is relatively low. Here, the binder may be polymer 121.

As described above, according to one exemplary embodiment of the present disclosure, the resistive layers formed on the respective side surfaces of the cathode electrode restrict the movement of electrons or lithium ions at the side surfaces of the cathode electrode during the quick charging of the lithium ion secondary battery, thereby minimizing the lithium metal precipitation and the electrolyte reaction byproducts on the anode electrode to improve the quick charge characteristics.

On the other hand, the resistive layers 14 formed on the respective side surfaces (i.e. end faces) of the cathode electrode 10 may be formed by coating the side surfaces of the cathode electrode with a mixture solution of a binder and a solvent. According to an embodiment of the present disclosure, the resistive layers 14 are formed by coating the side surfaces (i.e., end faces) of the cathode electrode 10 with a mixture solution, in which various coating methods such as spray coating, electro spray coating (ESC), brush coating, and slit-nozzle coating can be used.

The binder is composed of one or more materials selected from the group consisting of carboxymethyl cellulose (CMC), styrene butadiene rubber (SBR), polyacrylic acid (PAA), poly(vinylidene fluoride) (PVdF), poly(vinyl alcohol) (PVA), and polyimide (PI). The solvent is composed of one or more materials selected from the group consisting of alcohol, pure water, -methyl-2-pyrrolidone (NMP), dimethylformamide (DMF), dimethylacetamide (DMA), and tetrahydrofuran (THF)

Depending on embodiment, the concentration of the mixture solution may be in a range of 0.5% to 20%. Here, when the concentration of the mixture solution is 0.5% or less, the solvent may penetrate excessively deep into the cathode electrode. On the contrary, when the concentration of the mixture solution is 20% or more, the solvent cannot penetrate into the cathode electrode, resulting in poor coating. Therefore, the concentration of the mixture solution is preferably in a range of 0.5% to 20%. However, this range is only an example, and the concentration of the mixture solution may vary depending on the coating method, the type of the binder, and the pores of the cathode electrode.

The mixture solution may include a solvent, one or more monomers, and an initiator. The monomer may be a vinyl group, an alkyl group, or any combination of the vinyl group and the alkyl group.

The monomer may be at least one material selected from the group consisting of alkyl methacrylate, alkyl acrylate, acrylonitrile, alkyl acetate, styrene, and butadiene; or vinyl alcohol; or a combination of vinyl alcohol and at least one material selected from the group consisting of alkyl methacrylate, alkyl acrylate, acrylonitrile, alkyl acetate, styrene, and butadiene.

The concentration of the initiator is 0.5% to 5% by weight with respect to the total weight of the monomer.

Alternatively, the mixture solution may contain a metal oxide or a metal hydroxide in a concentration of 0.5% to 5% with respect to the total weight of the mixture solution. Here, the metal oxide or the metal hydroxide is contained in the mixture solution to enable an operator to easily discern whether the resistive layers are coated on the trimmed surfaces or not when forming the resistive layers by applying the mixture solution to the trimmed surfaces of the cathode electrode.

Specifically, the metal oxide may be SiO₂, Al₂O₃, Al₂(OH)₃, TiO₂, Mg(OH)₂, BaS0₄, TiO₂, SnO₂, CeO₂, ZrO₂, BaTiO₃, Y₂O₃ or B₂O₃. In this case, D50 of the metal oxide may be 0.1 μm to 2 μm.

On the other hand, the metal hydroxide may be Al(OH)₃ or Mg(OH)₂.

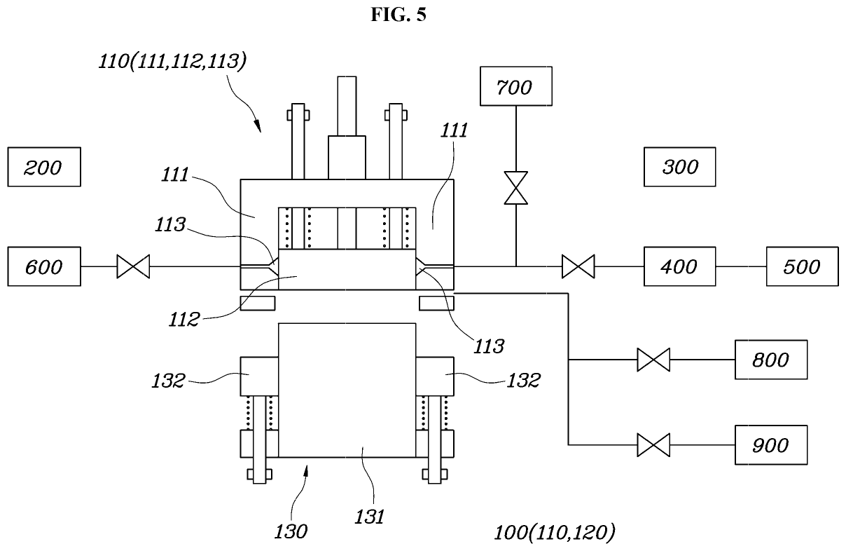

FIG. 5 is a view illustrating the overall construction of a lithium ion secondary battery manufacturing system according to one exemplary embodiment of the present disclosure. Referring to FIG. 5, a lithium ion secondary battery manufacturing system according to one exemplary embodiment of the present disclosure includes a cutter/coater 100, an electrode feeder 200, an electrode discharger 300, and a coating solution feeder 400. The system may further include at least one device selected from among a coating solution container 500, a vacuum device 600, a cleaning solution feeder 700, a particle remover 800, and a dryer 900.

The cutter/coater 100 trims a cathode electrode to have a predetermined size and coats the surfaces of the cathode electrode, which are exposed through the trimming of the cathode electrode, with a coating solution, thereby forming resistive layers on the respective trimmed surfaces of the cathode electrode. Specifically, the cutter/coater 100 includes an upper mold 110 and a lower mold 130.

More specifically, the upper mold includes a cutter 111 movable up and down and configured to trim the cathode electrode, a fixing part 112 for fixing the cathode electrode when trimming the cathode electrode, and a coater 113 for spraying a coating solution to the trimmed surfaces of the cathode electrode. Here, as illustrated in FIG. 5, the upper mold 110 may be provided with an elastic member, and the elastic member may be compressed or decompressed when the cutter 111 moves upward or downward.

The lower mold 130 includes a mounting portion 131 in which the cathode electrode can be mounted and a support portion 132 movable upward and downward. The support portion 132 supports the cathode electrode mounted in the mounting portion from the sides of the cathode electrode. The support portion 132 moves downward when the cathode electrode is trimmed by the cutter and supports the cathode electrode from the trimmed surfaces. Here, as illustrated in FIG. 5, the lower mold 130 may be provided with an elastic member, and the elastic member may be compressed or decompressed when the support portion 132 moves upward or downward.

The electrode feeder 200 is a device for supplying the cathode electrode to the cutter/coater 100, and the electrode discharger 300 is a device for discharging the trimmed and coated cathode electrode from the cutter/coater 100. The coating solution feeder 400 is a device for supplying the coating solution to the cutter/coater 100.

The coating solution container 500 may be a device that serves to store the coating solution. The vacuum device 600 creates a negative pressure around the trimmed surfaces (i.e., end faces) of the cathode electrode before the coating solution is sprayed to trimmed surfaces by the cutter/coater and removes the remaining coating solution on the trimmed surfaces before the coating is finished.

The cleaning solution feeder 700 is a device for supplying the cleaning solution to the trimmed surfaces of the cathode electrode. The particle remover 800 serves to remove the particles escaping from the trimmed surfaces of the cathode electrode after the cathode electrode is trimmed. The dryer 900 is a device that serves to dry the coated trimmed surfaces of the cathode electrode.

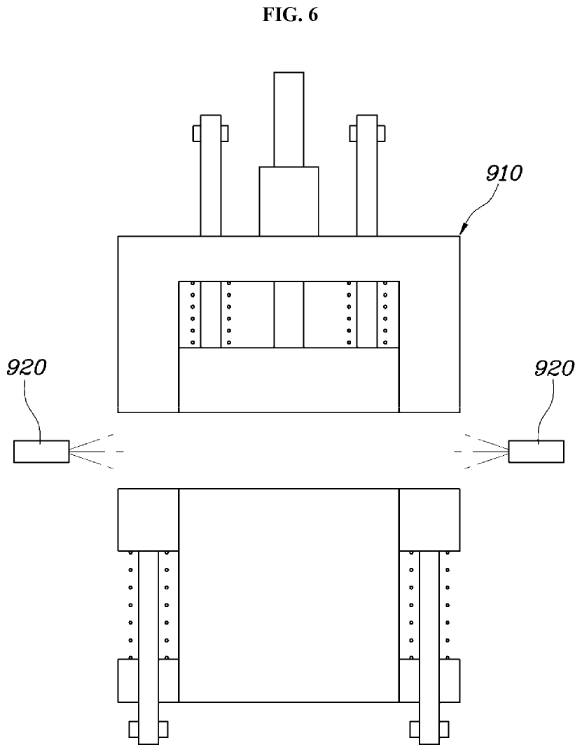

FIG. 6 is a view illustrating the overall construction of a lithium ion secondary battery manufacturing system according to another exemplary embodiment of the present disclosure. Referring to FIG. 6, in a lithium ion secondary battery manufacturing system according to another exemplary embodiment of the present disclosure, a cutter 910 and a coater 920 are separated from each other. The lithium ion secondary battery manufacturing system according to this exemplary embodiment is the same as the lithium ion secondary battery manufacturing system according to the former exemplary embodiment except for the cutter 910 and the coater 920 are separated from each other. Therefore, the points that are common between the former exemplary embodiment and the present exemplary embodiment will not be described.

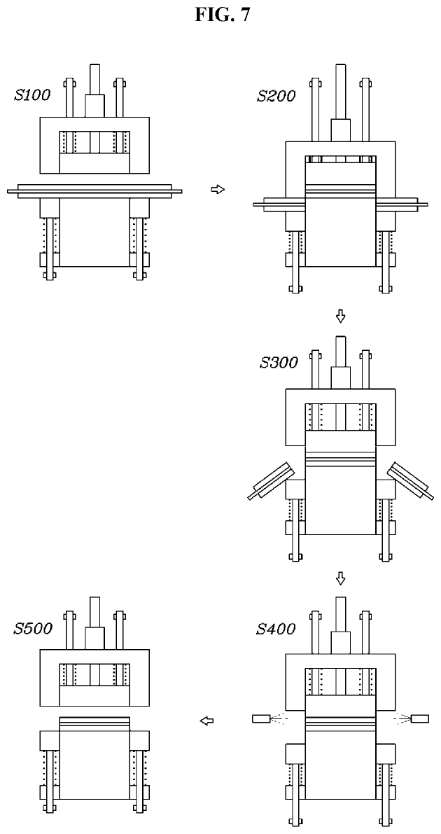

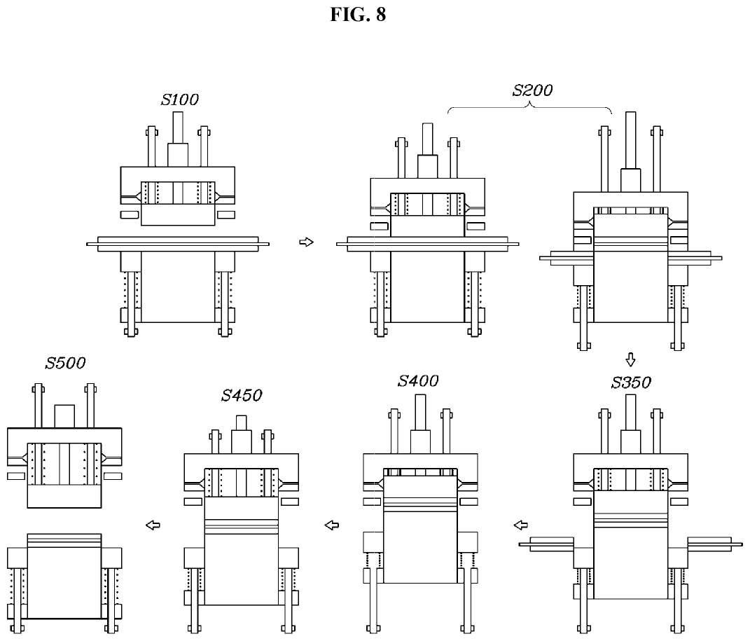

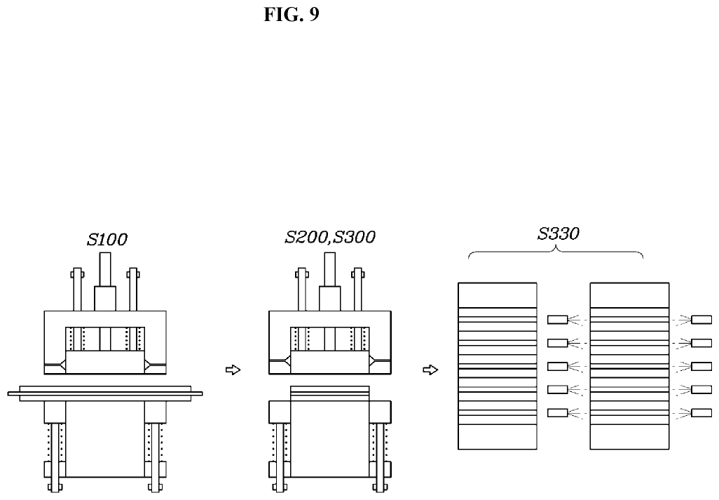

FIG. 7 is a view illustrating a method of manufacturing a lithium ion secondary battery, according to a first exemplary embodiment of the present disclosure, FIG. 8 is a view illustrating a method of manufacturing a lithium ion secondary battery, according to a second exemplary embodiment of the present disclosure, and FIG. 9 is a view illustrating a method of manufacturing a lithium ion secondary battery, according to a third exemplary embodiment of the present disclosure.

Referring to FIG. 7, the method according to the first exemplary embodiment of the present disclosure includes: Step S100 of loading a cathode electrode into a cutter/coater; Step S200 of lowering an upper mold of the cutter/coater to move a cutter downward while fixing the cathode electrode with a fixing part in order to trim the cathode electrode to have a predetermined size; Step S300 of moving the cuter upward while fixing the trimmed cathode electrode with the fixing part; Step S400 of spraying a coating solution to form resistance layers on respective trimmed surfaces of the cathode electrode; and Step S500 of unloading the cathode electrode with the coated trimmed surfaces.

Referring to FIG. 8, the method according to the second embodiment of the present disclosure may further include Step S350 of removing particles escaping from the trimmed surfaces of the cathode electrode in comparison with the method according to the first exemplary embodiment, in which Step S350 is performed before Step S400 at which the trimmed surfaces of the cathode electrode are coated.

The method according to the second embodiment may further include Step S450 of drying the coated trimmed surfaces of the cathode electrode in comparison with the method according to the first exemplary embodiment, in which Step S450 is performed before Step S500 at which the cathode electrode having undergone the trimming and the coating is unloaded.

Referring to FIG. 9, the method according to the third embodiment of the present invention may further include Step S330 of stacking multiple cathode electrodes that are trimmed to have a predetermined size and of forming resistive layers on the trimmed surfaces of the multiple cathode electrodes stacked on each other in comparison with the first embodiment or the second embodiment, in which Step S330 is performed after Step S300 at which the cutter is moved upward while the trimmed cathode electrode is fixed.

Although the present disclosure has been described and illustrated with reference to the particular embodiments thereof, it will be apparent to a person skilled in the art that various improvements and modifications of the present disclosure can be made without departing from the technical idea of the present disclosure provided by the following claims.

1. A lithium ion secondary battery comprising:
a cathode electrode including a cathode current collector and a cathode coating layer coated on a surface of the cathode current collector;
resistive layers formed on respective side surfaces at respective ends of the cathode electrode;
an anode electrode including an anode current collector and an anode coating layer coated on a surface of the anode current collector; and
a separator disposed between the cathode electrode and the anode electrode.

2. The lithium ion secondary battery according to claim 1, wherein the resistive layers are made of a mixture of a conductive material and a binder.

3. The lithium ion secondary battery according to claim 2, wherein the conductive material and the binder in the mixture are mixed at a ratio of 1:1.1 to 1:10.

4. The lithium ion secondary battery according to claim 2, wherein the resistive layers are formed by coating the respective side surfaces at the respective ends of the cathode electrode with a mixture solution of a binder and a solvent.

5. The lithium ion secondary battery according to claim 4, wherein the binder comprises one or more materials selected from the group consisting of carboxymethyl cellulose (CMC), styrene butadiene rubber (SBR), polyacrylic acid (PAA), poly(vinylidene fluoride) (PVdF), poly(vinyl alcohol) (PVA), and polyimide (PI), and
wherein the solvent comprises one or more materials selected from the group consisting of alcohol, pure water, -methyl-2-pyrrolidone (NMP), dimethylformamide (DMF), dimethylacetamide (DMA), and tetrahydrofuran (THF)

6. The lithium ion secondary battery according to claim 4, wherein the mixture solution has a concentration of 0.5% to 20%.

7. The lithium ion secondary battery according to claim 4, wherein the mixture solution comprises a solvent, one or more monomers, and an initiator.

8. The lithium ion secondary battery according to claim 7, wherein the monomer comprises a vinyl group, an alkyl group, or any combination of a vinyl group and an alkyl group.

9. The lithium ion secondary battery according to claim 8, wherein the monomer comprises: vinyl alcohol; at least one material selected from among alkyl methacrylate, alkyl acrylate, acrylonitrile, alkyl acetate, styrene, and butadiene; or any combination of vinyl alcohol and at least one material selected from the group consisting of or a material selected from among alkyl methacrylate, alkyl acrylate, acrylonitrile, alkyl acetate, styrene, and butadiene.

10. The lithium ion secondary battery according to claim 7, wherein the initiator is contained in a concentration of 0.5% to 5% by weight with respect to a total weight of the one or more monomers.

11. The lithium ion secondary battery according to claim 4, wherein the mixture solution comprises a metal oxide or a metal hydroxide in a concentration of 0.5% to 5% by weight with respect to a total weight of the mixture solution.

12. A lithium ion secondary battery manufacturing system comprising:
a cutter/coater configured to trim a cathode electrode to have a predetermined size and configured to coat trimmed side faces of the cathode electrode with a coating solution to form resistive layers on the respective side faces;
an electrode feeder configured to feed an untrimmed cathode electrode to the cutter/coater;
an electrode discharger configured to discharge the trimmed and coated cathode electrode from the cutter/coater; and
a coating solution feeder configured to feed the coating solution the cutter/coater.

13. The lithium ion secondary battery manufacturing system according to claim 12, further comprising at least one device selected from among:
a coating solution container for storing the coating solution;
a vacuum device configured to create a negative pressure around the trimmed side surfaces of the cathode electrode before the coating solution is sprayed by the cutter/coater and configured to remove residue of the coating solution after the trimmed side surfaces of the cathode electrode are coated with the coating solution;
a cleaning solution feeder configured to feed a cleaning solution to the trimmed side surfaces of the cathode electrode;
a particle remover configured to remove particles escaping from the trimmed side surfaces of the cathode electrode; and
a dryer configured to dry the coated trimmed side surfaces of the cathode electrode.

14. The lithium ion secondary battery manufacturing system according to claim 12, wherein the cutter/coater may include an upper mold and a lower mold,
the upper mold comprises: a cutter being vertically movable and configured to trim the cathode electrode; a fixing part configured to fix the cathode electrode when trimming the cathode electrode; and a coater configured to spray the coating solution to the trimmed surfaces of the cathode electrode, and
wherein the lower mold comprises: a mounting portion in which the cathode electrode is mounted; and a support portion that is vertically movable, that supports the cathode electrode mounted in the mounting portion from the sides of the cathode electrode, that moves downward when both sides of the cathode electrode are trimmed by the cutter, and that supports the cathode electrode from the trimmed side surfaces of the cathode electrode.

15. A method of manufacturing a lithium ion secondary battery, the method comprising:
loading a cathode electrode into a cutter/coater;
trimming the cathode electrode to have a predetermined size by lowering an upper mold of the cutter/coater to move a cutter downward while fixing the cathode electrode with a fixing part;
moving the cutter upward while fixing the cathode electrode that is trimmed to have the predetermined size with the fixing part;
coating respective trimmed side surfaces of the cathode electrode by spraying a coating solution to the respective trimmed side surfaces with the cutter/coater, thereby forming resistive layers; and
unloading the cathode electrode having undergone the trimming and coating.

16. The method according to claim 15, further comprising removing particles escaping from the trimmed side surfaces of the cathode electrode before the coating of the trimmed side surfaces of the cathode electrode.

17. The method according to claim 15, further comprising drying the coated trimmed side surfaces of the cathode electrode before the unloading of the cathode electrode having undergone the trimming and the coating.

18. The method according to claim 15, further comprising: stacking a plurality of the cathode electrodes trimmed to have a predetermined size; and coating trimmed side surfaces of the stacked cathode electrodes to form resistive layers on the respective trimmed side surfaces.
